(19) United States
(12) Patent Application Publication
(10) Pub. No.: US 2024/0364821 A1
(43) Pub. Date: Oct. 31, 2024

(54) IMAGE FORMING APPARATUS, IMAGE FORMING SYSTEM, INSPECTION METHOD, AND NON-TRANSITORY RECORDING MEDIUM

(71) Applicant: Shinya NOHDOMI, Kanagawa (JP)

(72) Inventor: Shinya NOHDOMI, Kanagawa (JP)

(21) Appl. No.: 18/635,026

(22) Filed: Apr. 15, 2024

(30) Foreign Application Priority Data
Apr. 26, 2023 (JP) 2023-072320

(51) Int. Cl. H04N 1/00; G06T 7/00

(52) U.S. Cl. CPC H04N 1/00074; G06T 7/001; H04N 1/00005; H04N 1/00037; H04N 1/00045; H04N 1/00087; G06T 2207/10008; G06T 2207/30144

(57) ABSTRACT

An image forming apparatus includes a reading device to read a printed matter, and circuitry to generate a first image to be inspected from the printed matter, detect a defect on the printed matter based on a master image generated from print data of the printed matter and the first image, detect a defect on a second image to be inspected generated by the reading device without a sheet being passed, set an inspection exclusion area where a defect is not to be detected on the first image, the inspection exclusion area including a position of the defect detected on the second image, and display a position of the defect on the printed matter in a different manner based on a determination result indicating whether the defect on the printed matter is detected in the inspection exclusion area or in an area other than the inspection exclusion area.

### CROSS-REFERENCE TO RELATED APPLICATION

This patent application is based on and claims priority pursuant to 35 U.S.C. § 119 (a) to Japanese Patent Application No. 2023-072320, filed on Apr. 26, 2023, in the Japan Patent Office, the entire disclosure of which is hereby incorporated by reference herein.

### BACKGROUND

### Technical Field

Embodiments of the present disclosure relate to an image forming apparatus, an image forming system, an inspection method, and a non-transitory recording medium.

### Related Art

A printing system is known which includes a printing apparatus for forming an image on a sheet based on print data, and an inspection apparatus that reads the image with a reading device and compares the read image with a master image generated from the print data of the image. The inspection apparatus can evaluate the print quality in accordance with the result of the comparison. In order to appropriately evaluate the print quality, it is preferable that defects such as dirt are not present in the reading device.

### SUMMARY

In one aspect, an image forming apparatus includes a reading device to read a printed matter printed by a printing apparatus, and circuitry to generate a first image to be inspected, based on reading of the printed matter by the reading device, detect a defect on the printed matter based on a master image and the first image, the master image being generated from print data of the printed matter, detect a defect on a second image to be inspected, the second image being generated by the reading device without a sheet being passed, set an inspection exclusion area where a defect is not to be detected on the first image, the inspection exclusion area including a position of the defect detected on the second image, and display, on a display, a position of the defect on the printed matter in a different manner based on a determination result indicating whether the defect on the printed matter is detected in the inspection exclusion area or in an area other than the inspection exclusion area.

In another aspect, an image forming system includes a reading device to read a printed matter printed by a printing apparatus, and circuitry to generate a first image to be inspected, based on reading of the printed matter by the reading device, detect a defect on the printed matter based on a master image and the first image, the master image being generated from print data of the printed matter, detect a defect on a second image to be inspected, the second image being generated by the reading device without a sheet being passed, set an inspection exclusion area where a defect is not to be detected on the first image, the inspection exclusion area including a position of the defect detected on the second image, and display, on a display, a position of the defect on the printed matter in a different manner based on a determination result indicating whether the defect on the printed matter is detected in the inspection exclusion area or in an area other than the inspection exclusion area.

In another aspect, an inspection method includes generating a first image to be inspected based on reading of a printed matter by a reading device, the printed matter being printed by a printing apparatus, detecting a defect on the printed matter based on a master image and the first image, the master image being generated from print data of the printed matter, detecting a defect on a second image to be inspected, the second image being generated by the reading device without a sheet being passed, setting an inspection exclusion area where a defect is not to be detected on the first image, the inspection exclusion area including a position of the defect detected on the second image, and displaying, on a display, a position of the defect on the printed matter in a different manner based on a determination result indicating whether the defect on the printed matter is detected in the inspection exclusion area or in an area other than the inspection exclusion area.

In another aspect, a non-transitory recording medium storing a plurality of program codes which, when executed by one or more processors, causes the one or more processors to perform the method described above.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of a printing system according to an embodiment of the present disclosure;

FIG. 2 is a block diagram illustrating a configuration of a digital front end (DFE) according to the embodiment of the present disclosure;

FIG. 3 is a block diagram illustrating a configuration of a printer according to the embodiment of the present disclosure;

FIG. 4 is a block diagram illustrating a configuration of an inspection apparatus according to the embodiment of the present disclosure;

FIG. 5 is a diagram illustrating an example of job management information according to the embodiment of the present disclosure;

FIG. 6 is a flowchart of the processing executed after a defect detection process without sheet passing according to the embodiment of the present disclosure;

FIG. 7 is a flowchart of the processing for registering an inspection exclusion area according to the embodiment of the present disclosure;

FIG. 8 is a diagram illustrating a detection message indicating a defect in reading device and an inspection exclusion area setting screen displayed by the inspection apparatus, according to the embodiment of the present disclosure;

FIG. 9 is a diagram illustrating a detection result display screen displayed by the inspection apparatus, according to the embodiment of the present disclosure; and

FIG. 10 is a diagram illustrating the detection result display screen displayed by the inspection apparatus according to the embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An inspection apparatus and an inspection method performed by the inspection apparatus according to embodiments of the present disclosure are described below with reference to the drawings.

### Overview of Operation

A printing system according to the present embodiment actually reads a printed matter with a reading device, such as a sensor, and generates an image to be inspected (an example of the first image to be inspected, may be also referred to as an inspected image). Then, the printing system compares the image with a master image generated from print data formed on the printed matter to determine whether the printed matter has been output with the expected quality. In the case where a degree of difference between the image to be inspected and the master image is determined to be equal to or more than a certain value (that is, a defect is present), the difference is likely to be caused by either some kind of failure occurred in the printing process or a defect such as dirt is present in the reading device. However, since an operator does not know whether the detected defect is caused by the printing process or by the defect such as the dirt present in the reading device, there is a case where the operator has to clean the reading device. In such a case, the productivity of producing printed matter decreases. When a defect is detected, in order to present an appropriate maintenance method to the operator, the printing system is required to determine whether the cause of the defect has occurred in reading or printing.

In view of the above, the printing system according to the present embodiment detects a defect in the reading device without actually reading the printed matter (referred to as “without sheet passing” in the following description), and sets an area surrounding the position where the defect is detected as an inspection exclusion area.
1. The printing system generates an image to be inspected without sheet passing. The generated image is an example of the second image to be inspected. The image to be inspected generated without sheet passing is an image generated by the reading device reading a predetermined reference plane. In the case where a defect such as dirt is not present in the reading device, the image to be inspected generated without sheet passing is a uniform image mostly formed of white pixels or black pixels as a whole.
2. The printing system detects a defect with the image to be inspected generated without sheet passing.
3. The printing system sets an inspection exclusion area including the position where the defect is detected on the inspected image generated in the defect detection process without sheet passing. Alternatively, the operator may set the inspection exclusion area with reference to the detected defect.

The printing system does not detect a defect detected in the inspection on an actual print as a defect in the case where the defect is present within the inspection exclusion area. In addition, the operator can set the system to display the defect present within the inspection exclusion area as a “suspected defect caused by reading failure.” Accordingly, in the case where the defect detected during the inspection on an actual print is present within the inspection exclusion area, the printing system notifies the operator of the defect as a suspected defect caused by reading failure in a manner different from the manner for an ordinary defect. The operator can determine whether the cause of the defect is the reading or the printing depending on the determination whether or not the defect detected during the inspection on an actual print is present within the inspection exclusion area.

The printing system according to the present embodiment detects a defect caused by the reading device before actually starting printing and notifies the operator of the defect present within the inspection exclusion area as a suspected defect caused by reading failure. As a result, cleaning for preventing the detection of the defect caused by the reading device is obviated.

### Terminology

The image to be inspected is an image used for inspecting print quality and is an image generated by optically reading the printed matter with the reading device. The image to be inspected includes both an image generated by reading a printed matter and an image generated by reading the reference plane without sheet passing.

The master image is an image formed on the printed matter based on print data and is an image serving as a reference for print quality.

The defect refers to a point where a standard for print quality is not satisfied, or a state where a standard is not satisfied. The defect includes both a defect that occurs in an inspected image generated from printed matter and a defect that occurs in an inspected image generated when the reference plane is read without sheet passing. In the former case, the print quality is considered to have deteriorated. The deterioration of the print quality may be caused by a defect in the printing process or dirt in the reading device. In the latter case, there is a possibility that dirt is present in the reading device.

The inspection exclusion area is an area in which, even when a defect is detected on a printed matter inspected during execution of a print job, the defect is treated as not being detected.

### Configuration of Printing System

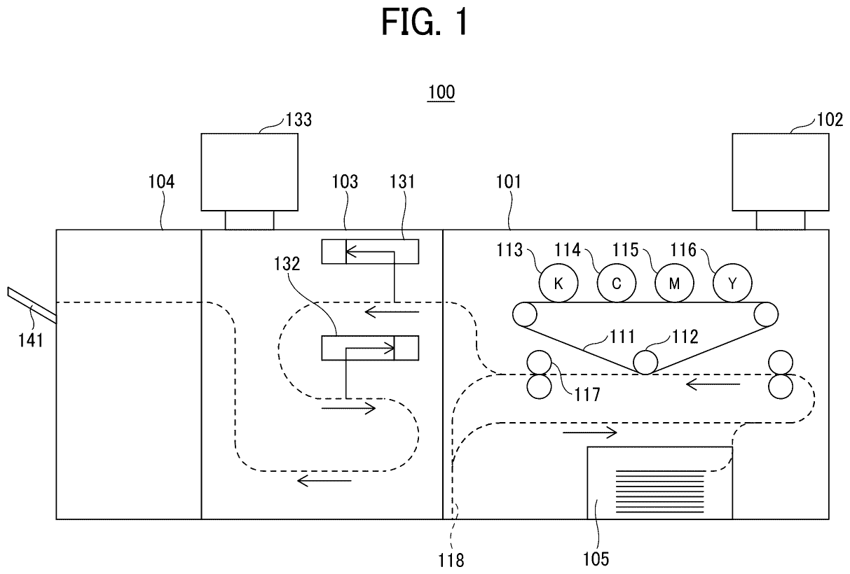

FIG. 1 is a schematic diagram illustrating a configuration of a printing system 100 according to an embodiment of the present disclosure. The configuration of the printing system 100 illustrated in FIG. 1 is given by way of example, and any configuration that can detect a defect described in the present embodiment may be used.

The printing system 100 includes a printer 101, an inspection apparatus 103, and a stacker 104. The printing system 100 may be referred to as, for example, an image forming apparatus, an image forming system, or a multifunction peripheral/printer/product (MFP). All or two of the printer 101, the inspection apparatus 103, and the stacker 104 may be integrated into one apparatus. The printer 101 is an apparatus that receives data such as characters, images, or graphics, and prints images on, for example, a sheet based on the data. The printer 101 may also be referred to as a printing apparatus.

An operation panel 102 of the printer 101 is disposed on the top face of the printer 101. The operation panel 102 includes a display (touch panel) and a keyboard, and displays an operation screen. The operation panel 102 displays an operation screen for operating the printing system 100 and receives various kinds of operations from the operator.

The printer 101 receives a print job that includes a raster image processing (RIP) image from an external device such as a digital front end (DFE) to be described later or a personal computer (PC), or receives an instruction to execute a print job stored in the printer 101. In the present embodiment, the RIP image is assumed to be formed in 8 bits for each of cyan, magenta, yellow, and black (CMYK) colors, as an image with 600 dot per inch (dpi).

The printer 101, in accordance with the contents of a print job instructed to be executed, acquires a sheet from a sheet feeder 105 and conveys the sheet along a path indicated by a dotted line in FIG. 1. The printer 101 forms an image on the sheet using drums 113, 114, 115, and 116. The toner images of black (K), cyan (C), magenta (M), and yellow (Y) respectively formed on the drums 113, 114, 115, and 116 are superimposed on a belt 111 to form a full-color toner image. Then, the full-color toner image is transferred onto the sheet conveyed to a roller 112 and fixed onto the sheet by a roller pair 117 using heat and pressure. In the case of single-sided printing, the sheet is ejected to the inspection apparatus 103 without any other process. In the case of double-sided printing, the sheet is reversed in a reverse path 118 and conveyed to the roller 112. Then, another full-color toner image formed by the drums 113, 114, 115, and 116 is also transferred and fixed onto the back face of the sheet and the sheet is ejected to the inspection apparatus 103.

The inspection apparatus 103 is an apparatus for inspecting the print quality of the printed matter output by the printer 101. The inspection apparatus 103 includes an operation panel 133 of the inspection apparatus 103. The functions of the operation panel 133 may be the same as those of the operation panel 102. The inspection apparatus 103 may not include the operation panel 133, and the operation panel 102 of the printer main body may also serve as the operation panel 133. Alternatively, the operation panel 133 of the inspection apparatus 103 may be a PC connected via, for example, a local area network (LAN). In this case, the PC displays the inspection result using, for example, a web browser or a dedicated application.

The inspection apparatus 103 separately reads an image on each face of the sheet ejected from the printer 101 using reading devices 131 and 132, conveys the sheet along with the path in a direction indicated by arrows, and ejects the sheet to the stacker 104. Each of the reading devices 131 and 132 is an example of reading means, which may be implemented by a sensor. In the present embodiment, the image read by each of the reading devices 131 and 132 is assumed to be formed in 8 bits for each of red, green, and blue (RGB) colors as an image with 200 dpi.

The stacker 104 stacks the sheet ejected from the inspection apparatus 103 on a tray 141.

### Digital Front End (DFE)

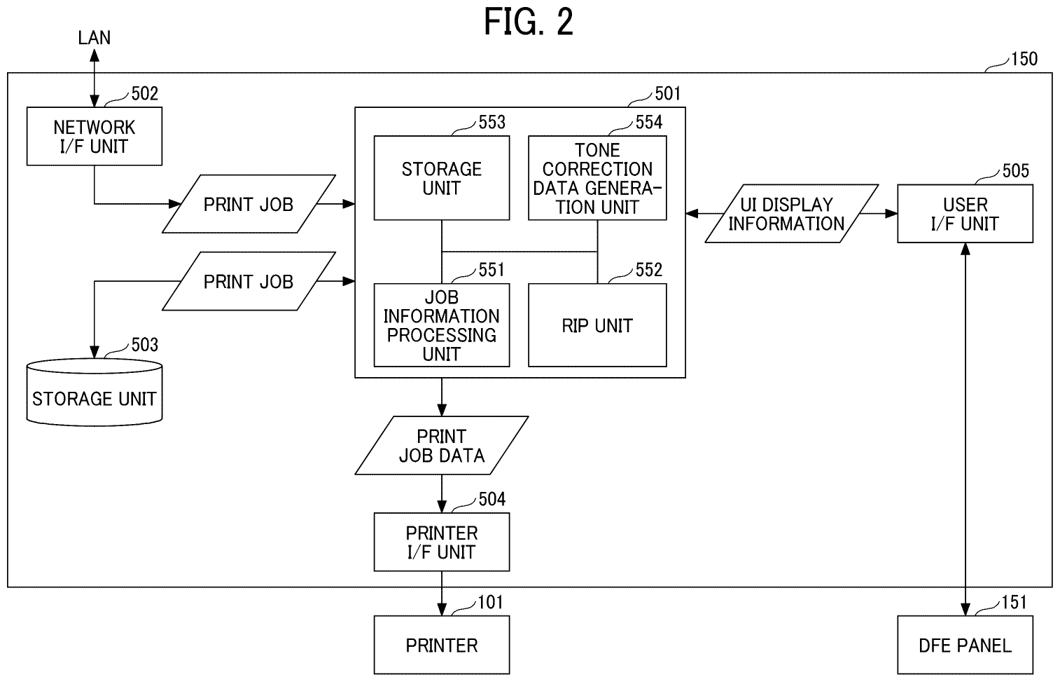

Referring to FIG. 2, a digital front end (DFE) 150 is described below. The digital front end (DFE) is a general term representing devices that process data to be input to a printer. The DFE 150 generates RIP data to be printed by the printer 101 from print data such as POSTSCRIPT data.

FIG. 2 is a block diagram illustrating a configuration of the DFE 150 according to the embodiment of the present disclosure. The printer 101 in FIG. 1 and a DFE panel 151 for displaying a user interface are connected to the DFE 150. The DFE panel 151 is a user interface that includes a display (touch panel) and a keyboard.

The DFE 150 includes a system control unit 501, a network interface (I/F) unit 502, a user I/F unit 505, a storage unit 503, and a printer I/F unit 504. In one example, these units provide functions implemented by circuitry such as a CPU of the DFE 150 executing instructions included in one or more programs installed in the DFE 150.

The user I/F unit 505 of the DFE 150, which is implemented by an interface circuit, generates a screen to be displayed on the DFE panel 151 using user interface (UI) display information, and causes the DFE panel 151 to display the screen. The UI display information includes a plurality of display components that form the screen and the arrangement thereof.

The network I/F unit 502 of the DFE 150, which is implemented by an interface circuit, is a communication interface for communication to connect the DFE 150 to the LAN. The network I/F unit 502 receives a print job through the LAN and transmits the print job to the system control unit 501.

Alternatively, the print job may be stored in the storage unit 503 that is implemented by any desired memory, and the system control unit 501 acquires the print job from the storage unit 503. In other words, the system control unit 501 may receive the print job via the network I/F unit 502 or may acquire the print job from the storage unit 503.

The DFE 150 includes the system control unit 501. The system control unit 501 controls the entire operation of the DFE 150. The system control unit 501 includes a job information processing unit 551, a RIP unit 552, a storage unit 553, and a tone correction data generation unit 554.

The job information processing unit 551 manages, as job management information relating to the print job, the status of the print job, the input of the print job to the printer 101, and the progress of the print job (obtained from the printer 101) in the storage unit 553, for example. The job information processing unit 551 inputs print job data to the printer 101 together with the job management information and the data of the RIP image. In the storage unit 553, the print job data relating to the print job (e.g., a job identification (ID), a file name, a job registration date and time, a job owner) are stored.

The tone correction data generation unit 554 adjusts the print data so that the print data is printed with the same tone, density, and color as those of the original document. For example, the tone correction data generation unit 554 strengthens or weakens the tone, increases or decreases the density, or increases or reduces warm colors or blue colors.

The RIP unit 552 generates RIP data to be printed by the printer 101 from print data such as POSTSCRIPT data. The RIP data is dot data (whether dots are formed or not) of the toner of each color.

The printer I/F unit 504 of the DFE 150, which may be implemented by an interface circuit, is an interface for communicating with the printer 101. The printer I/F unit 504 transmits the print job data determined to be input by the system control unit 501 to the printer 101.

### Printer

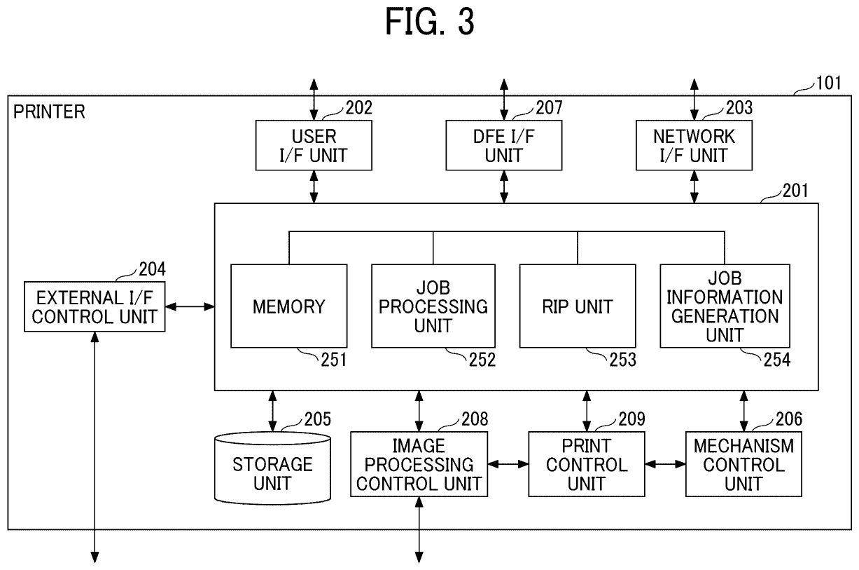

FIG. 3 is a block diagram illustrating a configuration of the printer 101 according to the embodiment of the present disclosure. The printer 101 includes a system control unit 201, a user I/F unit 202, a DFE I/F unit 207, a network I/F unit 203, an external I/F control unit 204, a storage unit 205, an image processing control unit 208, a print control unit 209, and a mechanism control unit 206. In one example, these units provide functions implemented by circuitry such as a CPU of the printer 101 executing instructions included in one or more programs installed in the printer 101.

The system control unit 201 controls the entire operation of the printer 101. To the system control unit 201, the user I/F unit 202, the DFE I/F unit 207, the network I/F unit 203, the external I/F control unit 204, the storage unit 205, the image processing control unit 208, the print control unit 209, and the mechanism control unit 206 are connected.

The user I/F unit 202, which may be implemented by an interface circuit, is an interface for connecting the system control unit 201 and the operation panel 102 illustrated in FIG. 1.

The DFE I/F unit 207, which may be implemented by an interface circuit, is an interface for enabling communication (for example, reception of print job data) between the system control unit 201 and the DFE 150 illustrated in FIG. 2.

The network I/F unit 203, which may be implemented by an interface circuit, is an interface for connecting the system control unit 201 to a network such as the LAN and allowing the printer 101 to communicate with devices on the network.

The external I/F control unit 204, which may be implemented by an interface circuit, is an interface through which the printer 101 communicates with other devices (such as the inspection apparatus 103 and the stacker 104).

The storage unit 205 is a storage device implemented by, for example, a hard disk drive (HDD) or a solid state drive (SSD). In the storage unit 205, for example, the print job data is stored.

The mechanism control unit 206 controls the operation of each mechanism in the printer 101, such as sheet conveyance, an image transfer process, and control of double-sided or single-sided printing within the printer 101.

The print control unit 209 instructs the mechanism control unit 206 to control the timing of each mechanism, and also controls the entire operation of image formation on the sheet. The image processing control unit 208 processes the image transferred by the mechanism control unit 206.

The system control unit 201 includes a memory 251, a job processing unit 252, a RIP unit 253, and a job information generation unit 254. The memory 251 is a memory used as a work area for the system control unit 201. In response to receiving the print job data from the DFE 150, the job information generation unit 254 generates, for example, a job ID used in the printer, a reception date and time, and progress, and stores the generated information in the storage unit 205. The RIP unit 253 executes the raster image processing on the print data in the case where the raster image processing has not been executed on the print job. The job processing unit 252 inquires of the print control unit 209 about the availability for print jobs, and determines a print job to be executed from among the print job data stored in the storage unit 205, for example, according to the priority.

### Inspection Apparatus

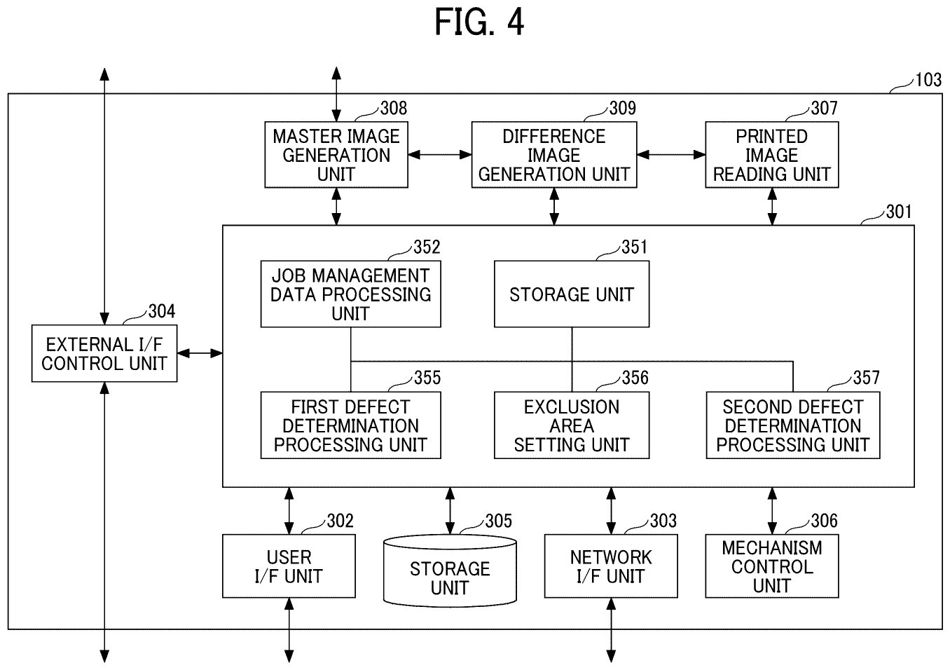

FIG. 4 is a block diagram illustrating a configuration of the inspection apparatus 103 according to the embodiment of the present disclosure. The inspection apparatus 103 includes a system control unit 301, a master image generation unit 308, a difference image generation unit 309, a printed image reading unit 307, an external I/F control unit 304, a user I/F unit 302, a storage unit 305, a network I/F unit 303, and a mechanism control unit 306. In one example, these units provide functions implemented by circuitry such as a CPU of the inspection apparatus 103 executing instructions included in one or more programs installed in the inspection apparatus 103.

The system control unit 301 controls the entire operation of the inspection apparatus 103. To the system control unit 301, the master image generation unit 308, the difference image generation unit 309, the printed image reading unit 307, the external I/F control unit 304, the user I/F unit 302, the storage unit 305, the network I/F unit 303, and the mechanism control unit 306 are connected.

The user I/F unit 302 is an interface for connecting the system control unit 301 and the operation panel 133 illustrated in FIG. 1. The user I/F unit 302 causes the operation panel 133 to display the information of the system control unit 301. In the case where a position of a defect detected during the inspection on an actual print overlaps with the inspection exclusion area, the user I/F unit 302 displays the defect as a suspected defect caused by reading failure in a manner different from the manner for an ordinary defect.

The network I/F unit 303 is an interface for connecting the system control unit 301 to a network such as the LAN.

The external I/F control unit 304 is an interface for connection with other devices (for example, the printer 101 and the stacker 104).

The mechanism control unit 306 controls the operation of each mechanism of the inspection apparatus 103, such as sheet conveyance, reading of both faces or one face of a sheet, and ejection of a sheet.

The storage unit 305 is a storage device implemented by, for example, an HDD or an SSD. In the storage unit 305, for example, an image to be inspected, a difference image, a master image, and an inspection result are stored. In the storage unit 305, the inspection exclusion area is also stored.

The printed image reading unit 307 reads both faces of the sheet conveyed from the printer 101 with the reading devices 131 and 132, and outputs an image to be inspected. The printed image reading unit 307 generates an image to be inspected in defect detection processes in both a detection mode during actual printing and a detection mode without sheet passing, which will be described later. The detection mode during actual printing is a mode in which a printed matter is inspected during execution of a print job. The detection mode without sheet passing is a mode in which a defect in the reading device 131 or 132 is detected before execution of a print job starts.

In the defect detection process in actual printing, the master image generation unit 308 generates a master image from the RIP image transmitted by the DFE 150. This RIP image is generated from print data to be formed on the sheet.

In the defect detection process in actual printing, the difference image generation unit 309 generates a difference image between the master image and the image to be inspected. The difference image is an image that represents the difference in pixel value for each pixel between the master image and the image to be inspected. Since the RIP image is generated from the print data to be formed on the sheet and the image to be inspected is generated by reading the printed matter, the pixel value of the difference image is smaller than a threshold value under normal conditions.

The system control unit 301 includes a storage unit 351, a job management data processing unit 352, a first defect determination processing unit 355, a second defect determination processing unit 357, and an exclusion area setting unit 356.

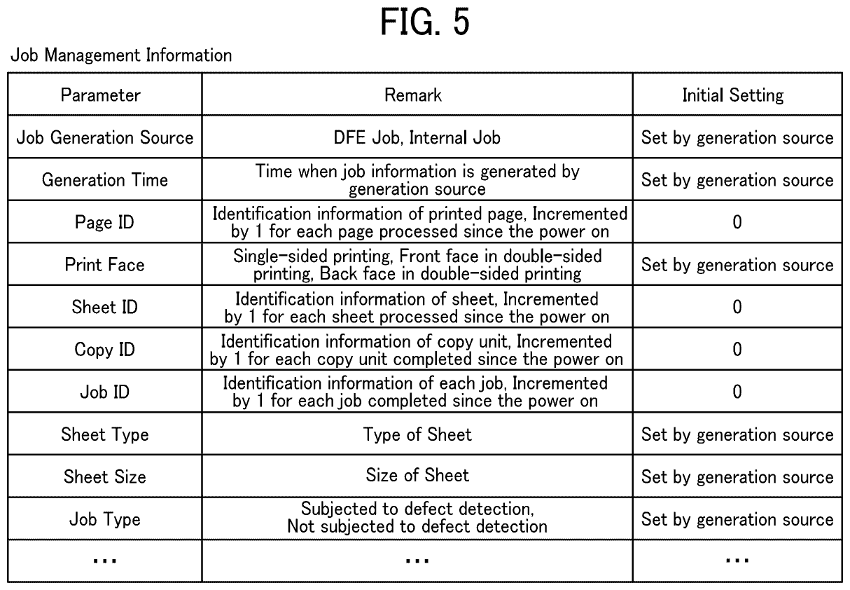

In the defect detection process in actual printing, the system control unit 301 receives print management information (included in the job management information) via the external I/F control unit 304, and stores the print management information in the storage unit 351 of the system control unit 301. The job management data processing unit 352 extracts post-processing device information from the job management information illustrated in FIG. 5 and transmits, via the external I/F control unit 304, the post-processing device information to the stacker 104 that is a post-processing device operating at a stage subsequent to the operation of the inspection apparatus 103. The job management data processing unit 352 reads out the print management information from the storage unit 351. The job management data processing unit 352 transfers the print management information to the master image generation unit 308, the difference image generation unit 309, the printed image reading unit 307, and the mechanism control unit 306 in order for the master image generation unit 308, the difference image generation unit 309, the printed image reading unit 307, and the mechanism control unit 306 to process the print job. The print management information to be transferred is the job management information illustrated in FIG. 5 from which the post-processing device information is removed.

In the defect detection process in actual printing, the system control unit 301 causes the storage unit 351 to store the image to be inspected and the difference image, and notifies the first defect determination processing unit 355 of the storage. The first defect determination processing unit 355 performs defect determination on the difference image according to a predetermined threshold value for defect determination. The first defect determination processing unit 355 performs, for example, edge detection on the difference image to detect an edge having an intensity higher than the threshold value for defect determination. The edge to be detected may be of any shape, such as a point or a line.

In the defect detection process without sheet passing, the system control unit 301 causes the storage unit 351 to store the image to be inspected and notifies the second defect determination processing unit 357 of the storage. The second defect determination processing unit 357 performs defect determination on the image to be inspected according to the predetermined threshold value for defect determination. In the case where the defect such as dirt is not present in the reading device, the image to be inspected generated in the defect detection process without sheet passing is a uniform image mostly formed of white pixels or black pixels to the whole. The master image is an image in which white or black pixels are formed over the entire face. Alternatively, the master image may not be required. The second defect determination processing unit 357 performs edge detection on the image to be inspected to detect an edge having an intensity higher than the threshold value for defect determination. The edge to be detected may be of any shape, such as a point or a line.

The exclusion area setting unit 356 excludes the position of the defect detected by the second defect determination processing unit 357 or the position of the defect set by the operator from the area where the first defect determination processing unit 355 detects a defect. In other words, the exclusion area setting unit 356 sets an inspection exclusion area where the first defect determination processing unit 355 does not detect a defect so that the position of the defect detected by the second defect determination processing unit 357 is included in the inspection exclusion area.

FIG. 5 is a diagram illustrating an example of the job management information according to the embodiment of the present disclosure. This job management information is used for the case where the printer 101 executes an ordinary printing process (i.e., the defect detection process in actual printing). In the printing process, print data is generated for each page by at least one of the DFE 150 and the printer 101. The print job is processed based on the job management information.

The job management information includes, as data items, a parameter, a remark, and an initial setting. The parameter is a name of an item. The remark is an explanation of the parameter. The initial setting indicates a setting when the system control unit 201 of the printer 101 receives the parameter.

A job generation source is information indicating a source that outputs a job. In the job generation source, information indicating whether the job is a print job input from the DFE 150 or internal data of the printer 101 is included.

A generation time is information indicating the date and time when the job generation source has generated the job.

A page ID is an identification number of a printed page. The page ID is incremented by one for each page processed since the time the power supply is turned on. A numerical value is set to the page ID when printing is executed.

A print face identifies whether the print job is single-sided printing or double-sided printing. In the case where the print job is identified to be double-sided printing, the print face identifies whether a face on which an image is to be printed is the front face (double-sided front) or the back face (double-sided back) of the sheet.

A sheet ID is identification information of a sheet used for printing. In the case of double-sided printing, the page IDs of pages printed on the same sheet has the same sheet ID. The sheet ID is incremented by one for each sheet processed since the time the power supply is turned on. A numerical value is set to the sheet ID when printing is executed.

A copy ID is identification information for each copy unit. The copy ID is incremented by one for each time the output of a copy unit is completed since the power supply is turned on. A numerical value is set to the copy ID when printing is executed.

A job ID is identification information for each job. The job ID is incremented by one for each time the output of a job is completed since the power supply is turned on. A numeric value is set to the job ID when printing is executed.

A sheet type is information on a type of a sheet used for printing. A sheet size is information on a size of the sheet. A job type indicates whether the print job is a print job subject to defect detection or a print job not subject to defect detection, or whether the print job involves an insertion sheet used for identifying defect detection.

### Defect Detection Process

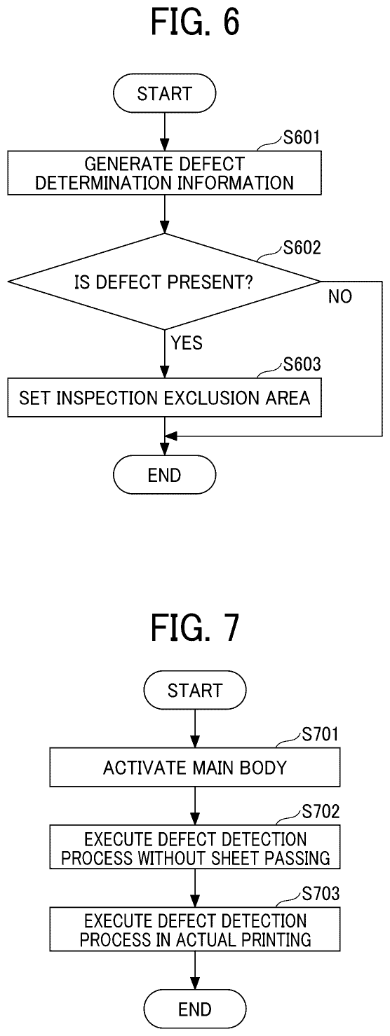

FIG. 6 is a flowchart of the processing executed after a defect detection process without sheet passing according to the embodiment of the present disclosure. The processing of FIG. 6 is executed after a defect detection process without sheet passing is executed and the second defect determination processing unit 357 executes a defect detection process on the image to be inspected. In the defect detection process without sheet passing, the printed image reading unit 307 generates an image to be inspected in a state where no sheet is conveyed. In the case where a defect is present on the inspected image, it is highly likely that the defect (e.g., dirt) is caused by the reading device 131 or 132.

First, the second defect determination processing unit 357 generates defect determination information (S601). The second defect determination processing unit 357 performs defect determination on the image to be inspected according to the predetermined threshold value for defect determination, and generates the following defect determination information.
1. Number of defects detected in reading when the defect detection process without sheet passing is executed.
2. Positions of the defects in reading when the defect detection process without sheet passing is executed.

The second defect determination processing unit 357 determines whether a defect is present based on the defect determination information (S602). In the case where a defect is not present (NO in S602), the processing of FIG. 6 ends.

In the case where a defect is present (YES in S602), the processing proceeds to setting of an inspection exclusion area (S603). In step S603, in the case where the preset manual adjustment for the inspection exclusion area is invalid, the exclusion area setting unit 356 sets an area surrounding the position where the defect is detected as the inspection exclusion area (S603). By excluding the position of the defect detected in the detection process in the detection mode without sheet passing from the area where a defect is detected when the detection process in the detection mode during actual printing is executed, cleaning for preventing the detection of the defect caused by the reading device 131 or 132 is obviated or the frequency of cleaning is reduced.

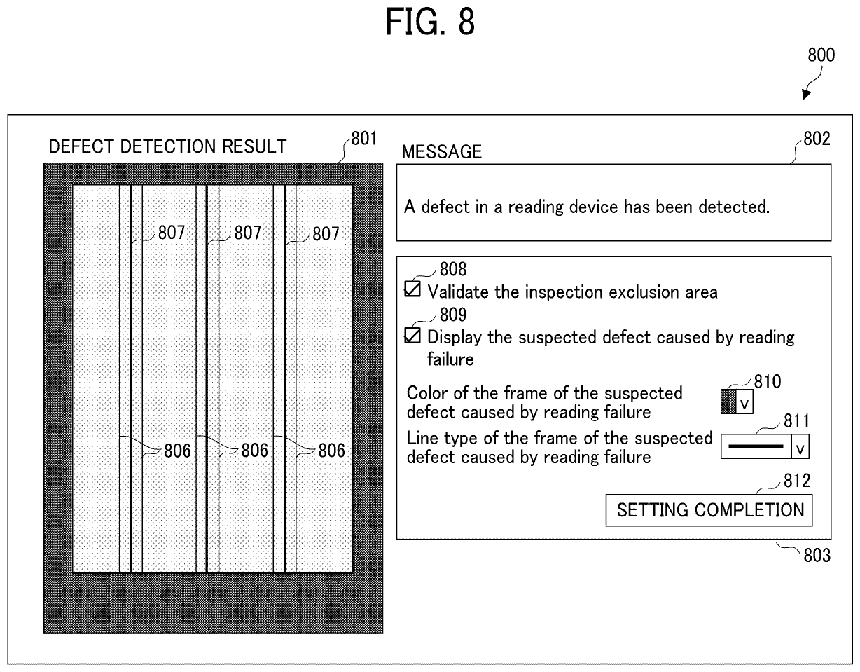

In the case where the preset manual adjustment for the inspection exclusion area is valid, an inspection exclusion area setting screen is displayed. The inspection exclusion area setting screen is given by way of example in FIG. 8. The user I/F unit 302 displays an inspection exclusion area set to include the detected defect. The operator operates the inspection exclusion area setting screen to adjust the inspection exclusion area. In addition, the operator can select whether to display the defect in the inspection exclusion area as a suspected defect caused by reading failure. The exclusion area setting unit 356 sets the inspection exclusion area set by the operator as the inspection exclusion area. The position where the defect occurs may vary somewhat. For this reason, by the operator designating the exclusion area with a margin in area, the position of the defect is prevented from being excluded from the inspection exclusion area.

FIG. 7 is a flowchart of the processing for registering an inspection exclusion area according to the embodiment of the present disclosure. The processing of FIG. 7 is executed, for example, when the power supply of the inspection apparatus 103 is turned on and the main body is activated (S701).

The system control unit 301 of the inspection apparatus 103 executes an operation in the detection mode without sheet passing in response to an operation of the operator or automatically (S702). In other words, before actual printing using an actual print job starts, the system control unit 301 executes a defect detection process on the reading devices 131 and 132 without a sheet being passed.

After the defect detection process without the sheet being passed is executed, the processing illustrated in FIG. 6 is executed. The system control unit 301 resets the inspection exclusion area to be registered in step S603 before the inspection exclusion area setting screen of step S603 is displayed to the operator. Then, the exclusion area setting unit 356 newly registers the inspection exclusion area set in step S603. The operation in the detection mode without sheet passing may be executed after the actual printing is completed.

When the defect detection process without sheet passing is executed, the system control unit 301 executes the defect detection process in actual printing (S703). In the defect detection process in actual printing, even when a defect is detected in the registered inspection exclusion area, the first defect determination processing unit 355 does not treat the defect as a defect (i.e., deterioration in print quality). In the defect detection process in actual printing, since a defect caused by the reading device 131 or 132 is excluded from detects to be detected, cleaning for preventing the detection of the defect is obviated or the frequency of cleaning is reduced.

In the present embodiment, even when a defect is detected in the inspection exclusion area, the defect is not treated as a defect. In addition, when the inspection exclusion area stored in the storage unit 351 by the second defect determination processing unit 357 overlaps with the position of the defect detected by the first defect determination processing unit 355, the first defect determination processing unit 355 determines the defect to be a suspected defect caused by reading failure. In this way, the operator can check whether or not the defect is caused by the reading device 131 or 132.

### Detection Message Indicating Defect in Reading Device and Inspection Exclusion Area Setting Screen

FIG. 8 is a diagram illustrating a detection message indicating a defect in reading device and an inspection exclusion area setting screen 800 displayed by the inspection apparatus 103, according to the embodiment of the present disclosure. The detection message indicating a defect in reading device and the inspection exclusion area setting screen are displayed in step S603 of FIG. 6.

The inspection exclusion area setting screen 800 is displayed in the defect detection process without sheet passing. On the inspection exclusion area setting screen 800, a defect detection result 801 is displayed. The defect detection result 801 is a part or the entirety of the image to be inspected generated in the defect detection process without sheet passing. The positions where defects are detected are surrounded by red frames 806. The inspection exclusion area is also set within each of the red frames 806 (for example, an area surrounded by a red frame 806 is set as an inspection exclusion area). In FIG. 8, three streaks 807 are defects. Since the defects are present on the inspected image generated in the defect detection process without sheet passing, dirt is assumed to be present in the reading device 131 or 132, or both.

On the inspection exclusion area setting screen 800, the detection message indicating a defect in reading device is also displayed. A detection message 802 indicating a defect in reading device is, for example, “A defect in a reading device has been detected.”

In the case where the preset manual adjustment for the inspection exclusion area is valid, an inspection exclusion area setting field 803 is displayed. The inspection exclusion area setting field 803 is a setting field for the operator to set the validity or invalidity of an inspection exclusion area where even a defect detected in the defect detection process in actual printing is not treated as a defect. The inspection exclusion area setting field 803 includes a check box 808 for validating the inspection exclusion area, a check box 809 for displaying a defect that is a suspected defect caused by reading failure, a selection field 810 for selecting a display color of the frame of the suspected defect caused by reading failure, a selection field 811 for selecting a line type of the frame of the suspected defect caused by reading failure, and an inspection exclusion area setting completion button 812.

It is assumed that the check box 808 for validating the inspection exclusion area is checked. In this case, even when a defect is detected in the defect detection process in actual printing, the first defect determination processing unit 355 does not treat the defect as a defect. It is assumed that the check box 809 for displaying a defect that is a suspected defect caused by reading failure is checked. In this case, when the first defect determination processing unit 355 detects a defect present in the inspection exclusion area in the defect detection process in actual printing, the user I/F unit 302 displays a suspected defect caused by reading failure. The operator can select a display color of the frame of the suspected defect caused by reading failure in the selection field 810, and can select a line type of the frame of the suspected defect caused by reading failure in the selection field 811. When the operator presses the inspection exclusion area setting completion button 812, the inspection exclusion area setting screen 800 is closed.

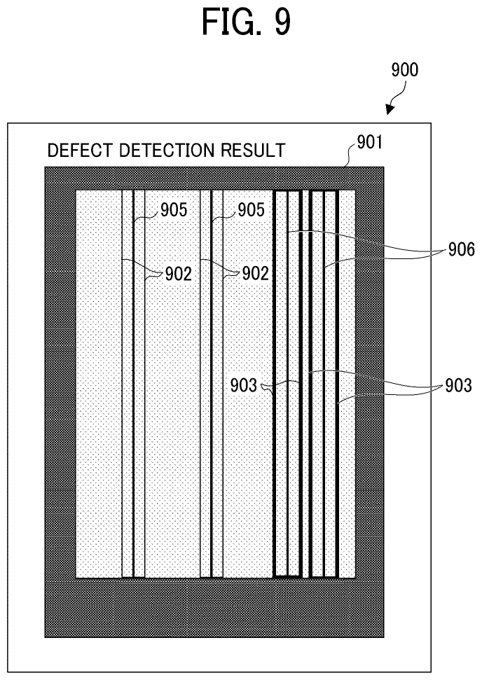

FIG. 9 is a diagram illustrating a detection result display screen 900 displayed by the inspection apparatus 103, according to the embodiment of the present disclosure. The detection result display screen 900 is displayed in a defect detection process in actual printing. On the detection result display screen 900, defects 905 detected in the defect detection process in actual printing (that is, with sheet passing) are displayed with red frames 902, and defects 906 that are suspected defects caused by reading failure are displayed with blue frames 903. The red frames 902 and the blue frames 903 are examples, and the operator can set the colors of the frames as desired. In this way, the user I/F unit 302 displays the positions of the defects in different manners depending on the determination whether the defects 906 of the printed matter are detected in the inspection exclusion area or the defects 905 of the printed matter are detected in areas other than the inspection exclusion area. The user I/F unit 302 displays a plurality of positions of defects in different manners on one detection result display screen 900.

The operator views the detection result display screen 900 and determines whether the positions of the defects detected in the defect detection process in actual printing overlap with the inspection exclusion area. In the case where the positions of the defects are determined to overlap with the inspection exclusion area, the operator can determine that the defects are caused by the reading devices, and can determine not to perform cleaning on each component in the printing process. In the case where the positions of the defects are determined not to overlap with the inspection exclusion area, the operator can determine that the print quality has deteriorated, and can determine to perform cleaning on each component in the printing process.

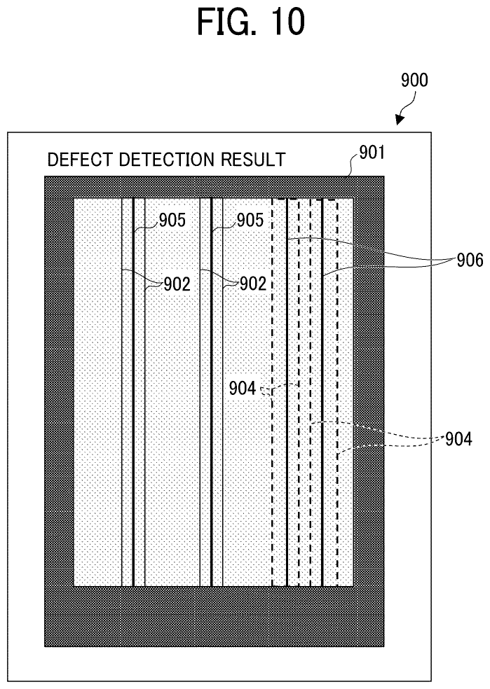

FIG. 10 is a diagram illustrating the detection result display screen 900 displayed by the inspection apparatus 103, as in FIG. 9, according to the embodiment of the present disclosure. On the detection result display screen 900 in FIG. 10, the defects 905 detected in the defect detection process in actual printing (that is, with sheet passing) are displayed with the red frames 902, and the defects 906 that are suspected defects caused by reading failure are displayed with red dotted line frames 904. The line types of the frames are examples, and the operator can set the line types of the frames as desired.

The manner in which the position of a defect is displayed is not limited to the difference in color or line type of the frame. The brightness of the frame may be changed or the color of the frame may be switched between color and monochrome, depending on the determination whether or not a position of a defect is present within an inspection exclusion area.

The printing system 100 of the present embodiment sets an inspection exclusion area when the detection process in the detection mode during actual printing is to be executed so that a position of a defect detected in a detection process in the detection mode without sheet passing is included in the inspection exclusion area. In the case where the position of a defect detected during the inspection on an actual print overlaps with the inspection exclusion area, the printing system 100 does not detect the defect as a defect, and notifies the operator of the defect as a suspected defect caused by reading failure, distinguishing the defect from an ordinary defect. Thus, cleaning for preventing the detection of the defect caused by the reading device 131 or 132 is obviated or the frequency of cleaning is reduced.

### Applied Cases

While some embodiments of the present disclosure have been described, the present disclosure is not limited to such embodiments and may be modified and substituted in various ways without departing from the spirit of the present disclosure.

The functional configuration according to the present embodiments illustrated in FIG. 4 is divided according to functions in order to facilitate understanding of the processing units executed by the inspection apparatus 103. No limitation to the scope of the present disclosure is intended by how the processing units are divided or by the names of the processing units. The processing units executed by the inspection apparatus 103 may be divided into a greater number of processing units in accordance with the contents of the processing units. In addition, a single processing unit can be divided to include a greater number of processing units.

The printer 101 is not limited to a printing device employing an electrophotographic method, but may be any printing device employing, for example, an inkjet printing system, a thermal transfer system, a letterpress method, a lithographic method, an intaglio method, or a stencil method.

Alternatively, the inspection apparatus 103 and the printer 101 may be separate bodies. In this case, the operator operates the inspection apparatus 103 to read the printed matter, and stores the inspection exclusion area determined by the inspection apparatus 103 in the printer owned by the operator.

The printing system 100 is not limited to the one used for commercial printing, and may be used in, for example, an office, a factory, an ordinary home, or a convenience store.

The processing of the inspection apparatus 103 described in the present embodiments may be executed by a server apparatus connected via a network. In this case, the inspection apparatus 103 transmits the image to be inspected to the server apparatus, and the server apparatus transmits the inspection result to the inspection apparatus 103. The inspection apparatus 103 receives the setting of the inspection exclusion area and registers the setting in the printer owned by the operator or the server apparatus.

Each of the functions of the embodiments described above may be implemented by one or more processing circuits or circuitry. The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), circuitry and/or combinations thereof which are configured or programmed to perform the disclosed functionality.

Aspects of the present disclosure are, for example, as follows.

### Aspect 1

An image forming apparatus includes:
a printed image reading unit that reads a printed matter printed by a printing apparatus with a reading device and generates a first image to be inspected;
a first defect determination processing unit that determines a defect present on the printed matter based on a master image generated from print data of the printed matter and the first image to be inspected;
a second defect determination processing unit that detects a defect present on a second image to be inspected generated by the reading device without a sheet being passed;
an exclusion area setting unit that sets an inspection exclusion area where the first defect determination processing unit does not detect a defect so that a position of the defect detected by the second defect determination processing unit is included in the inspection exclusion area; and;
a user interface (I/F) unit that displays a position of a defect in a different manner depending on a determination result indicating whether the first defect determination processing unit detects a defect present on the printed matter in the inspection exclusion area or detects a defect present on the printed matter in an area other than the inspection exclusion area.

### Aspect 2

In the image forming apparatus according to Aspect 1, the user I/F unit displays the position of the defect detected by the first defect determination processing unit in a different color depending on a determination result indicating whether the defect present on the printed matter is detected in the inspection exclusion area or the defect present on the printed matter is detected in the area other than the inspection exclusion area.

### Aspect 3

In the image forming apparatus according to Aspect 1, the user I/F unit surrounds the position of the defect detected by the first defect determination processing unit with a different type of a line depending on the determination result indicating whether the defect present on the printed matter is detected in the inspection exclusion area or the defect present on the printed matter is detected in the area other than the inspection exclusion area.

### Aspect 4

In the image forming apparatus according to any one of Aspects 1 to 3, when the second defect determination processing unit detects the defect present on the second image to be inspected, the user I/F unit displays the position of the detected defect and the inspection exclusion area surrounding the position of the detected defect.

### Aspect 5

In the image forming apparatus according to any one of Aspects 1 to 4, when the first defect determination processing unit detects the defect present on the printed matter in the inspection exclusion area, the user I/F unit receives a setting as to whether to display the position of the defect detected in the inspection exclusion area.

### Aspect 6

In the image forming apparatus according to any one of Aspects 1 to 5, when the first defect determination processing unit detects defects present on the printed matter in the inspection exclusion area and the area other than the inspection exclusion area, respectively, the user I/F unit displays a plurality of respective positions of the defects in different manners on one screen.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

Processors are considered processing circuitry or circuitry as they include transistors and other circuitry therein. In the disclosure, the circuitry, units, or means are hardware that carries out or is programmed to perform the recited functionality. The hardware may be any hardware disclosed herein or otherwise known which is programmed or configured to carry out the recited functionality.

1. An image forming apparatus comprising:
a reading device to read a printed matter printed by a printing apparatus; and
circuitry configured to:
generate a first image to be inspected, based on reading of the printed matter by the reading device;
detect a defect on the printed matter based on a master image and the first image, the master image being generated from print data of the printed matter;
detect a defect on a second image to be inspected, the second image being generated by the reading device without a sheet being passed;
set an inspection exclusion area where a defect is not to be detected on the first image, the inspection exclusion area including a position of the defect detected on the second image; and
display, on a display, a position of the defect on the printed matter in a different manner based on a determination result indicating whether the defect on the printed matter is detected in the inspection exclusion area or in an area other than the inspection exclusion area.

2. The image forming apparatus according to claim 1, wherein the circuitry is configured to display the position of the defect detected on the first image in a different color based on the determination result.

3. The image forming apparatus according to claim 1, wherein the circuitry is further configured to surround the position of the defect detected on the first image in a different type of a line based on the determination result.

4. The image forming apparatus according to claim 1, wherein the circuitry is configured to, in a case that the defect is detected on the second image, display the position of the detected defect and the inspection exclusion area surrounding the position of the detected defect.

5. The image forming apparatus according to claim 1, wherein the circuitry is configured to, in a case that the defect on the printed matter is detected in the inspection exclusion area, receive a setting as to whether to display the position of the defect detected in the inspection exclusion area.

6. The image forming apparatus according to claim 1, wherein the circuitry is configured to, in a case that the defect on the printed matter includes a first defect detected in the inspection exclusion area and a second defect detected in the area other than the inspection exclusion area, display positions of the first defect and the second defect in different manners on one screen.

7. An image forming system comprising:
a reading device to read a printed matter printed by a printing apparatus; and
circuitry configured to:
generate a first image to be inspected, based on reading of the printed matter by the reading device;
detect a defect on the printed matter based on a master image and the first image, the master image being generated from print data of the printed matter;
detect a defect on a second image to be inspected, the second image being generated by the reading device without a sheet being passed;
set an inspection exclusion area where a defect is not to be detected on the first image, the inspection exclusion area including a position of the defect detected on the second image; and
display, on a display, a position of the defect on the printed matter in a different manner based on a determination result indicating whether the defect on the printed matter is detected in the inspection exclusion area or in an area other than the inspection exclusion area.

8. An inspection method comprising:
generating a first image to be inspected based on reading of a printed matter by a reading device, the printed matter being printed by a printing apparatus;
detecting a defect on the printed matter based on a master image and the first image, the master image being generated from print data of the printed matter;
detecting a defect on a second image to be inspected, the second image being generated by the reading device without a sheet being passed;
setting an inspection exclusion area where a defect is not to be detected on the first image, the inspection exclusion area including a position of the defect detected on the second image; and
displaying, on a display, a position of the defect on the printed matter in a different manner based on a determination result indicating whether the defect on the printed matter is detected in the inspection exclusion area or in an area other than the inspection exclusion area.

9. A non-transitory recording medium storing a plurality of program codes which, when executed by one or more processors, causes the one or more processors to perform the method according to claim 8.
